(19) United States
(12) Patent Application Publication
(10) Pub. No.: US 2019/0243030 A1
(43) Pub. Date: Aug. 8, 2019

(54) ANTIREFLECTION FILM, POLARIZING PLATE, IMAGE DISPLAY DEVICE, AND ANTIREFLECTION PRODUCT

(71) Applicant: FUJIFILM Corporation, Tokyo (JP)

(72) Inventors: Takayasu YAMAZAKI, Kanagawa (JP); Shuntaro IBUKI, Kanagawa (JP)

(73) Assignee: FUJIFILM Corporation, Tokyo (JP)

(21) Appl. No.: 16/386,711

(22) Filed: Apr. 17, 2019

Related U.S. Application Data
(63) Continuation of application No. PCT/JP2017/035834, filed on Oct. 2, 2017.

(30) Foreign Application Priority Data
Oct. 25, 2016 (JP) 2016-209058

(51) Int. Cl. G02B 1/111; G02B 1/14

(52) U.S. Cl. CPC G02B 1/111; G02B 5/3025; G02B 1/14

(57) ABSTRACT

An antireflection film has a substrate and a layer of a low refractive index, the layer of a low refractive index contains inorganic particles and a binder resin, in a case where an average primary particle diameter of the inorganic particles is set as R, and particle spacing is set as K, an average particle spacing Ka satisfies Ka≥1.1R, and a full width at half maximum Kh in a distribution curve of the particle spacing K satisfies Kh≤0.25R, and a surface roughness of a surface of the layer of a low refractive index on an opposite side of the substrate is 20 nm or less. A polarizing plate, an image display device, and an antireflection product have the antireflection film.

### CROSS-REFERENCE TO RELATED APPLICATIONS

This application is a Continuation of PCT International Application No. PCT/JP2017/035834, filed on Oct. 2, 2017, which claims priority under 35 U.S.C. § 119(a) to Japanese Patent Application No. 2016-209058, filed on Oct. 25, 2016. Each of the above application(s) is hereby expressly incorporated by reference, in its entirety, into the present application.

### BACKGROUND OF THE INVENTION

### 1. Field of the Invention

The present invention relates to an antireflection film, a polarizing plate, an image display device, and an antireflection product.

### 2. Description of the Related Art

In an image display device such as a cathode ray tube display, a plasma display, an electroluminescent display, a vacuum fluorescent display, a field emission display, and a liquid crystal display device, an antireflection film may be provided in order to prevent decrease in the contrast due to reflection of external light on a display surface and reflected glare of an image. In addition to the image display device, the antireflection function may be imparted by an antireflection film.

As an antireflection film, there is known a film obtained by laminating a layer of a low refractive index having inorganic particles and a binder resin on a substrate, and for example, JP2016-075869A and JP2003-344603A disclose an antireflection film obtained by laminating a layer of a low refractive index including hollow particles such as hollow silica and a binder resin on a substrate.

### SUMMARY OF THE INVENTION

In recent years, demand for flexible displays has increased, and surface films excellent in repetitive folding resistance are strongly required. However, the antireflection film using the layer of a low refractive index in the related art has a problem of insufficient repetitive folding resistance.

An object of the present invention is to provide an antireflection film excellent in antireflection properties and repetitive folding resistance and exhibiting less deterioration in antireflection properties after repetitive folding, and a polarizing plate, an image display device, and an antireflection product that have the antireflection film.

The present inventors have conducted diligent research in order to achieve the object and have found that the object can be achieved by the following means.

<1> An antireflection film comprising: a substrate and a layer of a low refractive index,

in which the layer of a low refractive index contains inorganic particles and a binder resin,

in a case where an average primary particle diameter of the inorganic particles is set as R, and a particle spacing is set as K, an average particle spacing Ka satisfies Expression (1), and a full width at half maximum Kh in a distribution curve of the particle spacing K satisfies Expression (2), and

a surface roughness of a surface of the layer of a low refractive index on an opposite side of the substrate is 20 nm or less.

Ka≥1.1R (1)

Kh≤0.25R (2)

<2> The antireflection film according to <1>, in which the number of times of bending until breakage measured by a MIT tester in conformity with JIS P 8115:2001 is 10,000 times or more.

<3> The antireflection film according to <1> or <2>, in which an average primary particle diameter R of the inorganic particles is 200 nm or less.

<4> The antireflection film according to any one of <1> to <3>, in which the inorganic particle is an inorganic particle having a hollow structure.

<5> The antireflection film according to any one of <1> to <4>, further comprising: a hard coat layer between the substrate and the layer of a low refractive index.

<6> The antireflection film according to any one of <1> to <5>, in which a pencil hardness with a load of 500 g measured in conformity with JIS K 5600-5-4:1999 is 2H or more.

<7> The antireflection film according to any one of <1> to <6>, in which an average reflectivity in a wavelength range of 450 to 650 nm is 2% or less.

<8> The antireflection film according to any one of <1> to <7>, in which the substrate contains an aromatic polyamide.

<9> The antireflection film according to any one of <1> to <8>, in which the Kh is 0.20R or less.

<10> A polarizing plate comprising: the antireflection film according to any one of <1> to <9>.

<11> An image display device comprising: the antireflection film according to any one of <1> to <9> or the polarizing plate according to <10>.

<12> An antireflection product comprising: the antireflection film according to any one of <1> to <9>.

According to the present invention, it is possible to provide an antireflection film excellent in antireflection properties and repetitive folding resistance and exhibiting less deterioration in antireflection properties after repetitive folding, and a polarizing plate, an image display device, and an antireflection product that have the antireflection film.

### DESCRIPTION OF THE PREFERRED EMBODIMENTS

Hereinafter, the present invention will be described in detail with reference to embodiment, but the present invention is not limited thereto. In the present specification, in a case where a numerical value expresses a physical property value, a characteristic value, or the like, the expression “(numerical value 1) to (numerical value 2)” represents the meaning of “(numerical value 1) or more and (numerical value 2) or less”.

[Antireflection Film]

The antireflection film according to the embodiment of the present invention is an antireflection film including

a substrate and a layer of a low refractive index,

the layer of a low refractive index contains inorganic particles and a binder resin,

in a case where an average primary particle diameter of the inorganic particles is set as R, and a particle spacing is set as K, an average particle spacing Ka satisfies Expression (1), and a full width at half maximum Kh in a distribution curve of the particle spacing K satisfies Expression (2), and

a surface roughness of a surface of the layer of a low refractive index on an opposite side of the substrate is 20 nm or less.

Ka≥1.1R (1)

Kh≤0.25R (2)

<Layer of Low Refractive Index>

The antireflection film according to the embodiment of the present invention has the layer of a low refractive index on the substrate directly or via another layer.

(K, Ka, and Kh)

In a case where the average primary particle diameter of the inorganic particles included in the layer of a low refractive index of the antireflection film according to the embodiment of the present invention is set as R. and a particle spacing is set as K, the average particle spacing Ka and the full width at half maximum Kh of the particle spacing K in the distribution curve respectively satisfy Expressions (1) and (2). Here, the particle spacing K refers to a center-to-center distance of two particles present at the nearest position.

According to the present invention, K, Ka, and Kh are calculated as follows.

The antireflection film is cut in a thickness direction (perpendicular to the film surface) to obtain a cross section, the cross section is observed with a transmission electron microscope (JEM-1200EX II manufactured by JEOL Ltd.), the particle spacing K was obtained with respect to 500 inorganic particles, a number average value of the obtained K is calculated as Ka.

Subsequently, a frequency distribution curve of the obtained particle spacing K is drawn, a particle spacing (K₁ and K₂, here K₂>K₁ is satisfied) of ½ frequency of the particle spacing indicating a maximum frequency is obtained from the obtained distribution curve, and Kh is calculated from Expression (3).

Kh=(K₂−K₁)/R (3)

With respect to R, in the same manner as the method of obtaining the particle spacing K, the antireflection film is cut in the thickness direction, the cross section is observed with a transmission electron microscope, and an average value of the particle sizes that can be obtained as equivalent circle diameters with respect to 500 inorganic particles is set as the average primary particle diameter R.

As expressed in Expressions (1) and (2), the inorganic particle in the layer of a low refractive index of the antireflection film according to the embodiment of the present invention has the average particle spacing (Ka) in a predetermined proportion or more with respect to the average primary particle diameter (R), and the distribution of the particle spacing is also controlled. As a result, the stretchability of the entire layer of a low refractive index increases, and micro cracks of the film due to repetitive folding are suppressed. The present inventors presume that the decrease of the antireflection properties (hereinafter, also referred to as “repetitive folding antireflection durability”) after repetitive folding is suppressed.

Ka is 1.1 times or more of R, preferably 1.15 times or more, and more preferably 1.20 times or more in view of repetitive folding antireflection durability. In view of the antireflection properties, Ka is preferably 1.50 times or less of R and more preferably 1.40 times or less.

It is preferable that Kh is 0.25 times or less and 0.20 times or less of R.

(Refractive Index)

The refractive index of the layer of a low refractive index is preferably 1.30 to 1.51, more preferably 1.30 to 1.46, and even more preferably 1.32 to 1.38 in the wavelength of 550 nm. It is preferable to cause the refractive index to be in the above range, since the reflectivity is suppressed, and film hardness can be suppressed.

(Surface Roughness)

The surface roughness (Ra) of the surface of the layer of a low refractive index on an opposite side of the substrate is 20 nm or less. In a case where Ra is 20 nm or less, the visibility deterioration caused by the unevenness of the surface can be suppressed. Ra can be measured by a general surface roughness meter in conformity with Japanese Industrial Standard (JIS) B0601:1994, and for example, a stylus surface roughness meter “Surfcorder SE3500′” (manufactured by Kosaka Laboratory Ltd. is also preferably used. Ra is more preferably 10 nm or less, even more preferably 7 nm or less, and particularly preferably 5 nm or less.

(Inorganic Particle)

The inorganic particles contained in the layer of a low refractive index according to the embodiment of the present invention are not particularly limited as long as the refractive index of the layer of a low refractive index is in the above preferable range, and examples thereof include inorganic particles such as magnesium fluoride or silica.

The inorganic particles may be any one of crystalline or amorphous. The inorganic particles are preferably monodisperse particles. A shape of the inorganic particle is most preferably a spherical shape, but may be an amorphous shape.

In order to achieve a low refractive index, it is preferable to use inorganic particles having a porous structure or a hollow structure as the inorganic particles, and inorganic particles suitable for an agent of a low refractive index is silica (silicon oxide) particles having a hollow structure.

In order to improve the dispersibility in a binder for forming the layer of a low refractive index, the surface of the inorganic particle may be treated with at least one kind of hydrolyzate of organosilane and partial condensate thereof, and specific examples of the compound include compounds disclosed in paragraphs [0136] to [0145] of JP2007-298974A.

As the inorganic particles, specifically, inorganic fine particles disclosed in JP2007-298974A, and hollow silica fine particles disclosed in JP2002-317152A, JP2003-202406A, and JP2003-292831A can be suitably used.

The average primary particle diameter of the inorganic particles is preferably 200 nm or less, more preferably 10 nm to 200 nm, and even more preferably 50 to 120 nm. It is preferable that the average primary particle diameter of the inorganic particles is 200 nm or less, since both of the antireflection effect and black tight external appearance can be achieved. It is particularly preferable that the average primary particle diameter of the inorganic particles is set as 50 nm or more, scratch resistance in a case of use as an uppermost layer becomes satisfactory.

The refractive index of the inorganic particles is preferably 1.46 or less, more preferably 1.15 to 1.46, even more preferably 1.17 to 1.35, and particularly preferably 1.17 to 1.30.

It is preferable that the content of the inorganic particles in the layer of a low refractive index is adjusted such that the average particle spacing Ka of the inorganic particles is adjusted to satisfy Expression (1). Specifically, a filling rate of the inorganic particles in the layer of a low refractive index is preferably 39 volume % or less, more preferably 19 to 39 volume %, and even more preferably 25 to 35 volume %.

(Binder Resin)

The binder resin contained in the layer of a low refractive index is not particularly limited, as long as the refractive index of the layer of a low refractive index is in the above preferable range, and for example, well-known binder resins disclosed in JP2007-298974A, JP2002-317152A, JP2003-202406A, and JP2003-292831A can be used. The binder resin may be used singly or two or more kinds thereof may be used in combination. The binder resin is preferably a polymer of a monomer or an oligomer (polymerizable compound). Examples of the polymerizable compound include a monomer (a) used for forming a hard coat layer described below. The monomers may be used singly or two or more kinds thereof may be used in combination.

As the binder resin, a monomer having a high elongation percentage, in particular, a binder resin having an elongation percentage of 200% or more can be used in combination.

Here, the elongation percentage indicates an elongation amount (a distance obtained by subtracting an original gauge line distance from a breakage gauge line distance) until a substance in a film form is broken from an initial stage by the original gauge line distance, and is expressed by Expression (4). In Expression (4), E indicates an elongation percentage, E₂ indicates a breakage gauge line distance, and E₁ indicates an original gauge line distance.

E(%)=100×(E₂−E₁)/E₁ (4)

According to the present invention, the elongation percentage is calculated by using the breakage gauge line distance value measured according to JIS K6251:1993.

Examples of the commercially available binder resins having an elongation percentage of 200% or more include VYLON series (trade name) manufactured by Toyobo Co., Ltd. and SANPRENE series and SANRETAN series (both trade names) manufactured by Sanyo Chemical Industries, Ltd., and specifically, VYLON UR-1510, VYLON UR-2300, VYLON UR-3200, VYLON UR-3260, VYLON UR-8300, SANPRENE LQ-3300, SANPRENE LQ-3358, SANRETAN TIM-2011A, and the like can be preferably used. With respect to these binder resins, a compound obtained by introducing a polymerizable group into these binder resins to an extent that the elongation percentage is not deteriorated can also be suitably used.

(Coating Composition for Forming Layer of a Low Refractive Index)

It is preferable that the layer of a low refractive index is formed by coating with the coating composition for forming a layer of a low refractive index.

The coating composition for forming the layer of a low refractive index preferably contains the inorganic particles, the polymerizable compound for forming a binder resin, and a solvent. In this case, the concentration of solid contents of the coating composition for forming the layer of a low refractive index is appropriately selected, but is generally about 0.01 to 60 mass %, preferably 0.5 to 50 mass %, and particularly preferably about 1 to 20 mass %.

—Polymerization Initiator—

The polymerization initiator is not particularly limited, and well-known polymerization initiators may be used.

Examples of the polymerization initiator include polymerization initiators that can be used for forming a hard coat layer described below.

An addition amount of the polymerization initiator is not particularly limited, but is preferably 0.1 to 15 mass %, more preferably 0.5 to 10 mass %, and particularly preferably 1 to 5 mass % with respect to the total solid content in the composition for forming a layer of a low refractive index.

—Solvent—

A solvent included in a coating solution composition for a layer of a low refractive index is not particularly limited, as long as the polymerizable compound for forming a binder resin is uniformly dissolved or dispersed without precipitation, and the solvent may be used singly or two or more kinds thereof may be used in combination. Preferable examples include ketones (acetone, methyl ethyl ketone, methyl isobutyl ketone and the like), esters (ethyl acetate, butyl acetate, propylene glycol monomethyl ether acetate, and the like), ethers (tetrahydrofuran, 1,4-dioxane, and the like), alcohols (methanol, ethanol, isopropyl alcohol, butanol, ethylene glycol, and the like), aromatic hydrocarbons (toluene, xylene, and the like).

—Other Compounds—

For the purpose of providing performance such as antifouling performance, water resistance, chemical resistance, and sliding performance, well-known silicone-based or fluorine-based antifouling agent, lubricant, or the like can be appropriately added. In a case where these additives are added, it is preferable that the additives are added in the range of 0 to 20 mass %, more preferably in the range of 0 to 10 mass %, and particularly preferably 0 to 5 mass % with respect to the total solid content of the layer of a low refractive index.

(Method of Manufacturing Layer of a Low Refractive Index)

It is preferable that the layer of a low refractive index is formed by curing a coating composition in which inorganic particles, a polymerizable compound for forming a binder resin, and any components contained as desired are dissolved or dispersed, at the same time of coating or after coating and drying, by crosslinking reaction with ionizing radiation irradiation (light irradiation, electron beam irradiation, or the like) or heating, or the polymerization reaction.

A coating method of the coating composition for forming the layer of a low refractive index is not particularly limited, and a well-known method can be used. Examples thereof include a dip coating method, an air knife coating method, a curtain coating method, a roller coating method, a die coating method, a wire bar coating method, and a gravure coating method.

It is preferable that, after a substrate or a layer (for example, a hard coat layer) that may be present between the substrate or the layer of a low refractive index is coated with the coating composition for forming the layer of a low refractive index, a curing treatment is performed by at least several kinds of means such as heat or light irradiation.

(Film Thickness)

The film thickness of the layer of a low refractive index is preferably 200 nm or less, more preferably 50 nm to 120 nm, and even more preferably 80 to 120 nm.

<Substrate>

With respect to the substrate of the antireflection film according to the embodiment of the present invention, the transmittance in the visible range is preferably 70% or more and more preferably 80% or more.

It is preferable that the substrate includes a polymer resin.

(Polymer Resin)

As the polymer resin, a polymer excellent in optical transparency, mechanical strength, heat stability, and the like is preferable.

Examples thereof include a polyester-based polymer such as a polycarbonate-based polymer, polyethylene terephthalate (PET), and polyethylene naphthalate (PEN), an acrylic polymer such as polymethyl methacrvlate (PMMA), and a styrene-based polymer such as polystyrene and an acrylonitrile⋅styrene copolymer (AS resin). Examples thereof include polyolefin such as polyethylene and polypropylene, a polyolefin-based polymer such as a norbomene-based resin and an ethylene/propylene copolymer, an amide-based polymer such as a vinyl chloride-based polymer, nylon, and aromatic polyamide, an imide-based polymer, a sulfone-based polymer, a polyethersulfone-based polymer, a polyether ether ketone-based polymer, a polyphenylene sulfide-based polymer, a vinylidene chloride-based polymer, a vinyl alcohol-based polymer, a vinyl butyral-based polymer, an allylate-based polymer, a polyoxymethylene-based polymer, an epoxy-based polymer, a cellulose-based polymer represented by triacetyl cellulose, a copolymer of the above polymers or a polymer obtained by mixing the above polymers.

Particularly, an amide-based polymer such as aromatic polyamide can be preferably used as the substrate because the number of times of bending until breakage measured by an MIT tester according to JIS P8115:2001 is large and hardness is relatively high. For example, aromatic polyamide disclosed in Example 1 of JP5699454B can be preferably used as the substrate.

The substrate can also be formed as a cured layer of an ultraviolet curing-type or thermosetting-type resin such as acrylic resin, a urethane-based resin, an acrylic urethane-based resin, an epoxy-based resin, or a silicone-based resin.

(Softening Material)

The substrate may further contain a material for softening the polymer resin. The softening material refers to a compound that improves the number of bending until breakage, and as the softening material, a rubbery elastomer, a brittleness improver, a plasticizer, a slide ring polymer, or the like can be used.

Specifically, as the softening material, softening materials disclosed in paragraphs [0051] to [0114] in JP2016-167043A can be suitably used.

The above softening material may be mixed with the polymer resin singly, or a plurality thereof may be appropriately used in combination and mixed, and a softening material may be used singly or a plurality thereof may be used in combination without being mixed with the resin, so as to obtain a substrate.

The mixing amount of these softening materials can be, for example, 10 parts by mass with respect to 100 parts by mass of the polymer resin, but is not particularly limited. That is, the substrate may have the number of times of bending until breakage and may be formed of the polymer resin singly, a softening material may be mixed, or all may be formed of a softening material (100%).

(Other Additives)

Various additives (for example, an ultraviolet absorbing agent, a matte agent, an antioxidant, a peeling accelerator, a retardation (optical anisotropy), and a controlling agent) according to the application can be added to the substrate. These may be solid or oily. That is, the melting point or boiling point thereof is not particularly limited. The timing of adding the additives may be added at any point in the step of manufacturing the substrate, and a step of adding additives for preparation may be added to the material preparation step. The addition amount of each material is not particularly limited as long as the function is exhibited.

As other additives, additives disclosed in paragraphs [0117] to [0122] in JP2016-167043A can be suitably used.

The additives may be used singly or two or more kinds thereof may be used in combination.

In view of the transparency, with respect to the substrate, it is preferable that the refractive index difference between the flexible material or various additives used for the substrate and the polymer resin is small.

(Method of Manufacturing Substrate)

The substrate may be formed by thermally melting a thermoplastic polymer resin or may be casted by solution casting (solvent casting method) with a solution in which the polymer is uniformly dissolved. In the case of thermally melting film formation, the above softening material and various additives can be added at the time of thermal melting.

Meanwhile, in a case where the substrate is manufactured by the solution casting method, the above softening material and various additives can be added to a polymer solution (hereinafter also referred to as a dope) in each preparation step. The timing of adding the additives may any point in the step of manufacturing the dope, but a manufacturing step of adding and preparing the additives in the last preparation step of the dope preparation step may be added.

(Thickness of Substrate)

It is preferable that the thickness of the substrate is more preferably 100 μm or less, even more preferably 60 μm or less, and most preferably 50 μm or less. As the thickness of the substrate becomes smaller, the curvature difference between the front surface and the back surface in a case of being bent becomes smaller, cracks and the like are unlikely to occur, and breakage of the substrate does not occur even in a case where being bent is performed a plurality of times. Meanwhile, in view of easy handling of the substrate, the thickness of the substrate is preferably 10 μm or more and more preferably 15 μm or more. In view of reducing the thickness of the image display device into which the antireflection film is incorporated, the total thickness of the antireflection film is preferably 70 μm or less and more preferably 50 μm or less.

<Other Layers>

The antireflection film according to the embodiment of the present invention may have another layer between the substrate and the layer of a low refractive index. As the other layer, it is preferable to have a hard coat layer, the substrate and the hard coat layer may be in contact with each other, and another layer may be provided between the substrate and the hard coat layer.

(Hard Coat Layer)

In the antireflection film according to the embodiment of the present invention, a hard coat layer may be provided in order to provide physical strength of the film. It is preferable that the layer of a low refractive index is provided on the hard coat layer, because the scratch-resistant surface such as a pencil scratch test becomes strong. The hard coat layer may be formed of a laminate of two or more layers.

The refractive index of the hard coat layer in the wavelength of 550 nm is preferably 1.56 or more, more preferably 1.68 to 1.84, and even more preferably 1.71 to 1.81.

—Resin—

The hard coat layer preferably contains a resin, and the resin is preferably a polymer of a monomer (polymerizable compound).

The monomers may be used singly or two or more kinds thereof may be used in combination.

The monomer preferably has unsaturated polymerizable functional groups such as a (meth)acryloyl group, a vinyl group, a styryl group, and an allyl group. Among them, the monomer preferably has a (meth)acryloyl group.

Monomer (a)

It is preferable to use a monomer (also referred to as a “monomer (a)”) as the monomer for forming a resin of the hard coat layer. Specific examples of the monomer include (meth)acrylic acid diesters of alkylene glycol such as neopentyl glycol acrylate, 1,6-hexanediol (meth)acrylate, and propylene glycol di(meth)acrylate:

(meth)acrylic acid diesters of polyoxyalkylene glycol such as triethylene glycol di(meth)acrylate, dipropylene glycol di(meth)acrylate, polyethylene glycol di(meth)acrylate, and polypropylene glycol di(meth)acrylate;

(meth)acrylic acid diesters of polyhydric alcohol such as pentaerythritol di(meth)acrylate; and

(meth)acrylic acid diesters of an ethylene oxide or propylene oxide adduct such as 2,2-bis{4-(acryloxy⋅diethoxy)phenyl} propane, and 2-2-bis{4-(acryloxy⋅polypropoxy)phenyl} propane.

Epoxy (meth)acrylates, urethane (meth)acrylates, and polyester (meth)acrylates are also preferably used.

Among these, esters of polyhydric alcohol and (meth)acrylic acid are preferable. It is more preferable that it contains a polyfunctional monomer having three or more (meth)acryloyl groups in one molecule. That is, it is preferable that the hard coat layer contains a cured product of a polyfunctional monomer having three or more (meth)acryloyl groups in one molecule.

Examples thereof include pentaerythritol tetra(meth)acrylate, pentaerythritol tri(meth)acrylate, trimethylolpropane tri(meth)acrylate, ethylene oxide (EO)-modified trimethylolpropane tri(meth)acrylate, propylene oxide (PO)-modified trimethylolpropane tri(meth)acrylate, EO-modified phosphate tri(meth)acrylate, trimethylol ethane tri(meth)acrylate, ditrimethylolpropane tetra(meth)acrylate, dipentaerythritol tetra(meth)acrylate, dipentaerythritol penta (meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl) isocyanurate.

Monomer (b)

It is preferable that the monomer includes a compound (also referred to as a “monomer (b)”) having at least one skeleton selected from a fluorene skeleton, a dinaphthothiophene skeleton, a naphthalene skeleton, an anthracene skeleton, a benzotriazole skeleton, a triazine skeleton, a benzophenone skeleton, a merocyanine skeleton, a benzoxazole skeleton, a benzothiol skeleton, a triphenylene skeleton, a cinnamoyl skeleton, a bisphenol S skeleton, and a transform skeleton.

By using the monomer (b), the refractive index of the hard coat layer can be adjusted to be high. Specific examples of the monomer (b) include compounds represented by Formulae (I) to (VI) disclosed in paragraphs 0029 to 0046 of JP2007-091876A, fluorene compounds disclosed in paragraphs 0113 to 0115 JP2014-034596A, fused ring-containing compounds (preferably fused ring-containing compounds represented by Formula (3) of the same document) represented by Formula (1) of JP2014-080572A, compounds disclosed in paragraph 0016 of JP2013-253161A, compounds disclosed in paragraphs 0025 to 0153 of JP2006-301614A, compounds disclosed in paragraphs 0020 to 0122 of JP2007-108732A, and compounds disclosed in paragraphs 0012 to 0108 of JP2010-244038A.

As the monomer (b), a compound having at least one skeleton selected from a fluorene skeleton, a dinaphthothiophene skeleton, a naphthalene skeleton and an anthracene skeleton is particularly preferable, and a compound having a fluorene skeleton is most preferable.

—Inorganic Particle—

The hard coat layer may contain inorganic particles.

As the inorganic particles, particles of oxides of metals (for example, Ti, Zr, In, Zn, Sn, Sb, and Al) are preferable, and in view of the refractive index, zirconium oxide particles or titanium oxide particles are more preferable, and zirconium oxide particles (zirconia particles) are most preferable from the viewpoint that, in a case where the titanium oxide particles are caused to have an average primary particle diameter of less than 10 nm, the photoactivity is enhanced, and the surrounding organic matter can be easily decomposed.

The refractive index can be adjusted by changing the content ratio of the inorganic particles in the hard coat layer.

The content ratio of the inorganic particles in the hard coat layer is preferably 5 to 80 volume %, more preferably 10 to 60 volume %, and even more preferably 20 to 50 volume % with respect to the entire hard coat layer. In a case where the content ratio of the inorganic particles is 5 volume % or more, the refractive index of the hard coat layer increases, and in a case where the content ratio is 80 volume % or less, the film is easily formed.

The suitable content ratio of the inorganic particles in the hard coat layer in terms of mass % varies depending on the specific gravity of the inorganic particles. For example, the content ratio in a case of using zirconium oxide particles as the inorganic particles is preferably 21 to 95 mass %, more preferably 36 to 88 mass %, and even more preferably 56 to 83 mass % with respect to the entire hard coat layer.

The average primary particle diameter of the inorganic particles is preferably 1 to 80 nm, more preferably 1 to 40 nm, and even more preferably 2 to 20 nm.

It is preferable that the inorganic particle contains a resin described below as the binder component in the hard coat layer, and it is preferable that the inorganic particle is modified with the compound having a polymerizable group to provide a polymerizable group to a surface of the inorganic particle, in order to improve adhesiveness with the binder component in the hard coat layer.

The film thickness of the hard coat layer is not particularly limited, and is preferably 1 to 10 μm, more preferably 1.5 to 8 μm, and even more preferably 2 to 5 μm.

(Method of Manufacturing Hard Coat Layer)

It is preferable that the hard coat layer is manufactured by a manufacturing method including a step of coating the substrate with the composition for forming a hard coat layer and a step of polymerizing a monomer. The composition for forming the hard coat layer preferably contains an organic solvent in addition to the monomer or the inorganic particle.

Examples of the organic solvent used in a case of manufacturing the hard coat layer include a solvent having a boiling point of 200° C. or less at ordinary pressure. Specifically, alcohols, ketones, ethers, esters, hydrocarbons, amides are used, and these can be used singly or two or more kinds thereof may be used in combination. Among them, alcohols, ketones, ethers, and esters are preferable.

Here, examples of the alcohols include methanol, ethanol, isopropyl alcohol, isobutanol, n-butanol, tert-butanol, ethoxyethanol, butoxyethanol, diethylene glycol monoethyl ether, benzyl alcohol, and phenethyl alcohol. Examples of the ketones include acetone, methyl ethyl ketone, methyl isobutyl ketone, and cyclohexanone. Examples of the ethers include dibutyl ether and propylene glycol monoethyl ether acetate. Examples of the esters include ethyl acetate, butyl acetate, and ethyl lactate. Examples of the hydrocarbons include toluene and xylene. Examples of amides include formamide, dimethylacetamide, and N-methylpyrrolidone. Among these, isopropyl alcohol, ethoxyethanol, butoxyethanol, diethylene glycol monoethyl ether, methyl ethyl ketone, methyl isobutyl ketone, cyclohexanone, propylene glycol monoethyl ether acetate, butyl acetate, and ethyl lactate are preferable.

—Polymerization Initiator—

The composition for forming a hard coat layer may include a polymerization initiator.

In a case where the monomer is a photopolymerizable compound, it is preferable to include a photopolymerization initiator.

Examples of the photopolymerization initiator include acetophenones, benzoins, benzophenones, phosphine oxides, ketals, anthraquinones, thioxanthones, an azo compound, peroxides, 2,3-dialkyldione compounds, disulfide compounds, fluoroamine compounds, aromatic sulfoniums, lophine dimers, onium salts, borate salts, active esters, active halogens, an inorganic complex, and coumarins. Specific examples, preferable aspects, commercially available products and the like of the photopolymerization initiator are disclosed in paragraphs [0133] to [0151] of JP2009-098658A and can be appropriately used in the present invention in the in the same manner.

Various examples are provided in “Newest UV curing technology” (Technical Information Institute Co. Ltd.) (1991), page 159 and “Ultraviolet Curing System” written by Kiyomi KATO (published in 1989 by The Integrated Technology Center), pages 65 to 148, and are useful in the present invention.

The content ratio of the polymerization initiator in the composition for forming a hard coat layer is preferably 0.5 to 8 mass % and more preferably 1 to 5 mass % with respect to the total solid content in the composition for forming a hard coat layer.

The composition for forming a hard coat layer may contain a component in addition to the above, and examples thereof include a leveling agent or a dispersing agent.

The method of applying the composition for forming a hard coat layer is not particularly limited, and well-known methods can be used. Examples thereof include a dip coating method, an air knife coating method, a curtain coating method, a roller coating method, a wire bar coating method, a gravure coating method, and a die coating method.

A step of coating the substrate with the composition for forming a hard coat layer and performing heating may be provided. In the case of using a solvent which swells the substrate, a portion of the monomer can be effectively caused to permeate into the substrate by heating. The temperature in heating is preferably smaller than the glass transition temperature of the substrate. Specifically, the temperature is preferably 60° C. to 180° C. and more preferably 80° C. to 130° C.

In a case where the monomer is a photopolymerizable monomer, the polymerization of the monomer can be performed by irradiation with ionizing radiation. The kind of ionizing radiation is not particularly limited, and examples thereof include X-rays, electron beams, ultraviolet rays, visible light, and infrared rays. However, ultraviolet light is widely used. The irradiation amount is not particularly limited, but is preferably 10 mJ/cm² to 1,000 mJ/cm². At the time of irradiation, the energy may be applied at once or can be applied in a divided manner. As the ultraviolet lamp type, a metal halide lamp, a high pressure mercury lamp, or the like is suitably used.

<Physical Properties of Antireflection Film>

(Number of Times of Bending Until Breakage)

With respect to the antireflection film according to the embodiment of the present invention, it is preferable that the number of times of bending until breakage that is measured by MIT tester in conformity with JIS P 8115:2001 is 10,000 times or more. According to the present invention, the measurement of the number of times of bending until breakage is performed by folding the antireflection film such that the substrate of the antireflection film is on the inside.

(Average Reflectivity)

In view of antireflection properties, the average reflectivity of the antireflection film according to the embodiment of the present invention in the wavelength range of 450 to 650 nm is preferably 2% or less and more preferably 1.5% or less.

(Pencil Hardness)

With respect to the antireflection film according to the embodiment of the present invention, in view of film hardness, the pencil hardness with a load of 500 g measured in conformity with JIS K 5600-5-4:1999 is preferably 2H or more and more preferably 3H or more.

The antireflection film according to the embodiment of the present invention can be appropriately used as a polarizing plate protective film.

The polarizing plate protective film using the antireflection film according to the embodiment of the present invention can be bonded to a polarizer to form a polarizing plate and can be appropriately used in a liquid crystal display device or the like.

[Polarizing Plate]

The polarizing plate is a polarizing plate having a polarizer and at least one of the protective films for protecting the polarizer, and it is preferable that at least one of the protective films is the antireflection film according to the embodiment of the present invention.

The polarizer includes an iodine-containing polarizing film, a dye-based polarizing film using a dichroic dye, and a polyene-based polarizing film. The iodine-based polarizing film and the dye-based polarizing film can be generally manufactured by using a polyvinyl alcohol-based film.

[Image Display Device]

The antireflection film or the polarizing plate according to the embodiment of the present invention can be also applied to an image display device.

Examples of the image display device include a display device using a cathode ray tube, a plasma display panel, an electroluminescent display, a vacuum fluorescent display, a field emission display, and a liquid crystal display device, and a liquid crystal display device is particularly preferable.

Generally, a liquid crystal display device has a liquid crystal cell and two polarizing plates disposed on both sides of the liquid crystal cell, and the liquid crystal cell carries a liquid crystal between the two electrode substrates. One optically anisotropic layer may be disposed between the liquid crystal cell and one polarizing plate, or two optically anisotropic layers may be disposed between the liquid crystal cell and both polarizing plates. As the liquid crystal cell, liquid crystal cells of various driving methods such as a Twisted Nematic (TN) mode, a Vertically Aligned (VA) mode, an Optically Compensatory Bend (OCB) mode, and an In-Plane Switching (IPS) mode can be applied.

[Antireflection Product]

The antireflection film according to the embodiment of the present invention can be applied to devices other than the image display device, for example, by bonding the antireflection film according to the embodiment of the present invention on various articles to obtain an antireflection product provided with an antireflection function.

### EXAMPLES

The present invention will be more specifically described using the following examples, but the scope of the present invention is not construed to be limited thereto. Unless described otherwise. “parts” and “%” are based on mass.

[Manufacturing of Antireflection Film]

As described below, a hard coat layer was formed on a substrate by using a composition for forming a hard coat layer (coating solution), and then a layer of a low refractive index was formed on the hard coat layer such that an antireflection film was manufactured.

(Synthesis of Aromatic Polyamide)

674.7 kg of N-methyl-2-pyrrolidone, 10.6 g of lithium bromide anhydride (manufactured by Sigma-Aldrich Japan K.K.), 33.3 g of 2,2′-ditrifluoromethyl-4,4′-diaminobiphenyl (“TFMB” manufactured by Toray Fine Chemicals Co., Ltd.), and 2.9 g of 4,4′-diaminodiphenylsulfone (“44 DDS” manufactured by Wakayama Seika Co., Ltd.) were introduced into a polymerization tank equipped with a stirrer, were cooled to 15° C. in a nitrogen atmosphere, and 18.5 g of terephthalic acid dichloride (manufactured by Tokyo Chemical Industry Co., Ltd.) and 6.4 g of 4,4′-biphenyl dicarbonyl chloride (“4 BPAC” manufactured by Toray Fine Chemicals Co., Ltd.) were added in four portions over 300 minutes under stirring. After stirring for 60 minutes, hydrogen chloride generated in the reaction was neutralized with lithium carbonate so as to obtain a polymer solution.

(Manufacturing of Substrate Film S-1)

A portion of the polymer solution obtained above was casted on an endless belt at 120° C. using a T-die such that the final film thickness became 25 μm, was dried such that the polymer concentration became 40 mass %, and was peeled off from the endless belt. Subsequently, the film including the solvent was stretched 1.1 times in the machine direction (MD) in the atmosphere at 40° C., and the solution was removed by washing with water at 50° C. The film was stretched 1.2 times in the transverse direction (TD) in a drying oven at 340° C. to obtain a substrate film S-1 having a thickness of 25 μm which is formed of aromatic polyamide. According to JIS P 8115:2001 of the substrate film S-1, the number of times of bending until breakage measured by the MIT tester was 25,000 times.

(Preparation of Composition for Forming Hard Coat Layer)

With the following formulation, each component was introduced into a mixing tank, stirred, and filtered with a polypropylene filter having a pore size of 0.4 μm to prepare a composition HT-1 for forming a hard coat layer.

Formulation of composition HT-1 for forming hard coat layer

Curable compound A1: 1.59 parts by mass

Curable compound A2: 1.59 parts by mass

Zirconia dispersion ZB: 84.42 parts by mass

Photopolymerization initiator J1: 1.50 parts by mass

Toluene: 10.91 parts by mass

Curable compound A1: Mixture of dipentaerythritol pentaacrylate and dipentaerythritol hexaacrylate (Trade name: KAYARAD DPHA, manufactured by Nippon Kayaku Co., Ltd.)

Curable compound A2: a mixture of pentaerythritol tetraacrylate and pentaerythritol triacrylate (trade name: KAYARAD PET30, manufactured by Nippon Kayaku Co., Ltd.)

Zirconia Dispersion ZB: Zirconia particle-containing dispersion having an average primary particle diameter of 20 nm, 30 mass % solution of toluene (manufactured by CIK Nanotech Co., Ltd.)

Photopolymerization initiator J1: IRGACURE (Registered trademark) 184 (manufactured by BASF SE)

(Preparation of silica particle dispersion R-1)

33.5 parts by mass of γ-acryloyloxypropyltrimethoxysilane, 1.51 parts by mass of diisopropoxyaluminum ethyl acetate, and 500 parts by mass of methyl ethyl ketone were added to 500 parts by mass of a silica-based hollow fine particle dispersion sol (trade name: THRULYA 1420 manufactured by Catalysts & Chemicals Industries Co. Ltd., average primary particle diameter: 60 nm, concentration: 20.5 mass %, dispersion medium: isopropanol) and mixed, and 9 parts by mass of ion exchange water was added. This mixture solution was reacted at 60° C. for 10 hours, then cooled to room temperature (23° C.), and 1.8 parts by mass of acetylacetone was added to obtain a dispersion. Subsequently, while cyclohexanone was added so that the silica content was substantially constant, the solvent substitution by distillation under reduced pressure was performed at a pressure of 133.232 Pa., and finally, concentration adjustment was performed, so as to manufacture a hollow silica particle dispersion R-1 surface-modified with an organic silicon compound having a polymerizable functional group having a concentration of solid contents of 18.3 mass %.

(Preparation of Silica Particle Dispersion R-3)

A hollow silica particle dispersion R-3 having a concentration of solid contents of 17.9 mass % was manufactured in the same manner, except that a silica-based hollow fine particle dispersion sol (trade name: THRULYA 1420) in the manufacturing of the hollow silica particle dispersion R-1 was changed to trade name: THRULYA 1420-120 manufactured by Catalysts & Chemicals Industries Co. Ltd. (average primary particle diameter: 120 nm, concentration: 20.5 mass %, dispersion medium: isopropanol).

(Preparation of Composition for Layer of a Low Refractive Index)

Each component was introduced into a mixing tank to obtain the formulation (parts by mass) presented in Table 1, stirred, and filtered with a polypropylene filter having a pore diameter of 0.4 μm, so as to prepare compositions L1 to L9 for a layer of a low refractive index.

TABLE 1

| | L1 | L2 | L3 | L4 | L5 | L6 | L7 | L8 | L9 |
|---|---|---|---|---|---|---|---|---|---|
| Curable compound A1 | 5.54 | 6.04 | 7.00 | 4.20 | 7.49 | 6.04 | 6.04 | 6.04 | 4.22 |
| Curable compound A3 | | | | 2.80 | | | | | 1.81 |
| Photopolymerization initiator J1 | 0.30 | 0.30 | 0.30 | 0.30 | 0.30 | 0.30 | 0.30 | 0.30 | 0.30 |
| Silica dispersion R-1 | 20.84 | 18.11 | 12.86 | 12.86 | 10.18 | | 14.49 | 10.87 | |
| Silica dispersion R-2 | | | | | | 16.17 | 3.23 | 6.47 | |
| Silica dispersion R-3 | | | | | | | | | 18.52 |
| Lubricant M1 | 0.35 | 0.35 | 0.35 | 0.35 | 0.35 | 0.35 | 0.35 | 0.35 | 0.35 |
| PGMEA | 72.97 | 75.20 | 79.49 | 79.49 | 81.68 | 77.14 | 75.97 | 75.97 | 74.80 |
| Total | 100.00 | 100.00 | 100.00 | 100.00 | 100.00 | 100.00 | 100.00 | 100.00 | 100.00 |

Curable compound A3: Methacryloyl group-introduced compound of a urethane acrylate polymer in the trade name of SANRETAN TIM-2011A (manufactured by Sanyo Chemical Industries, Ltd., elongation percentage: 300%)

Silica Dispersion R-2: Silica-based hollow fine particle dispersion sol (trade name: THRULYA 1420, manufactured by Catalysts & Chemicals Industries Co., Ltd., average primary particle diameter: 60 nm)

Lubricant M1: Acryloyl-modified silicone-based lubricant (trade name X-22-164A, manufactured by Shin-Etsu Chemical Co., Ltd.)

PGMEA: Propylene glycol monomethyl ether acetate

[Manufacturing of Antireflection Film F-1]

The obtained substrate film S-1 was coated with the composition HT-1 for forming a hard coat layer with a gravure coater while the thickness of the hard coat layer was adjusted to 3 μm. The coated composition was dried at 120° C., purging with nitrogen was performed to have the atmosphere in which an oxygen concentration becomes 100 ppm or less, the composition was cured by the ultraviolet irradiation in an irradiation amount of 30 mJ/cm² with an air-cooled metal halide lamp (manufactured by Eye Graphics Co., Ltd.) of 160 w/cm, so as to prepare a hard coat film.

The hard coat layer of the obtained hard coat film was coated with the composition L for a layer of a low refractive index with a gravure coater. The coated composition was dried at 60° C., and purging with nitrogen was performed to have the atmosphere in which an oxygen concentration becomes 100 ppm or less, the composition was cured by the ultraviolet irradiation in an irradiation amount of 300 mJ/cm² with an air-cooled metal halide lamp (manufactured by Eye Graphics Co., Ltd.) of 160 w/cm, so as to prepare an antireflection film F-1. The thickness of the layer of a low refractive index was 100 nm.

In the manufacturing of the antireflection film F-1, antireflection films F-2 to F-9 were manufactured in the same manner, except that the composition for the layer of a low refractive index and the film thickness of the layer of a low refractive index were changed as presented in Table 2.

[Evaluation of Antireflection Film]

(Repetitive Folding Resistance)

A folding endurance tester (manufactured by Tester Industry Co., Ltd., MIT, model BE-201, folding radius: 0.4 mm) was used, an antireflection film sample having a width of 15 mm and a length of 80 mm that was left for one hour at 25° C. and a relative humidity of 65% was prepared, the antireflection film sample was folded such that the substrate was on the inside, measurement was performed under the condition of a load of 500 g in conformity with JIS P 8115:2001, and the number until breakage (the number of times of bending until breakage) was evaluated.

(Average Reflectivity)

In a state where backside reflection was removed by roughening the back surface of the antireflection film (the surface on an opposite side to the interface of the substrate film on the layer side of a low refractive index) with sandpaper and then treating the back surface with black ink, the average reflectivity was calculated by measuring a specular reflectivity at an incidence angle of 5° in the wavelength range of 450 to 650 nm by using a spectrophotometer V-550 (manufactured by JASCO Corporation), and the antireflection properties were evaluated in the following standards.

A: The specular reflectivity was less than 1.0%

B: The specular reflectivity was 1.0% or more and less than 1.5%

C: The specular reflectivity was 1.5% to 2%

(Repetitive Folding Antireflection Durability)

With respect to each antireflection film sample after 10,000 times of folding in a folding test of the repetitive folding resistance, the average reflectivity of the folded portion was measured by the method described above. The difference between the average reflectivity of the folded portion and the average reflectivity before the folding was calculated, and the repetitive folding antireflection durability was evaluated.

A: The reflectivity difference was within 0.1% (there was no external difference between a folded portion and a non-folded portion)

B: The reflectivity difference was greater than 0.1% and within 0.3% (there was a slight external difference, but it does not matter)

C: The reflectivity difference was greater than 0.3% (there was a clear difference, and it matters)

(Pencil Hardness Test)

With respect to each sample, the pencil hardness evaluation disclosed in JIS K 5600-5-4:1999 was performed under the condition of a load of 500 g. and then pencil marks were removed with an eraser. After humidity conditioning of each sample at a temperature of 25° C. and a relative humidity of 60% for three hours, the hardness evaluation was performed by using a test pencil specified in JIS S 6006:2007, and also, after the sample was left for three hours after the test in an environment of a temperature of 25° C. and a relative humidity of 60%, the evaluation was performed under the following conditions.

A: No scratches or tint changes were observed after the 2H test.

B: Scratches were not observed after the 2H test, but tint changes were observed.

C: Scratches or tint changes were observed after the 2H test.

(Refractive Index)

The refractive index of the layer of a low refractive index of the antireflection film in the wavelength of 550 nm was measured with a multiwavelength Abbe refractometer DR-M4 (trade name, manufactured by Atago Co., Ltd.).

Results thereof are as presented in Table 2.

In Table 2, the filling rate of the inorganic particles in the layer of a low refractive index was also presented. The filling rate of the inorganic particles was obtained by obtaining a projected area of the inorganic particles in the layer of a low refractive index with respect to the transmission electron microscope image of a cross section obtained by cutting the antireflection film in a thickness direction and calculating a value obtained by dividing the value by the total area of the layer of a low refractive index.

TABLE 2

| | Comparative | | | | | Comparative | Comparative | | |
|---|---|---|---|---|---|---|---|---|---|
| | Example 1 | Example 1 | Example 2 | Example 3 | Example 4 | Example 2 | Example 3 | Example 5 | Example 6 |
| Antireflection film number | F-1 | F-2 | F-3 | F-4 | F-5 | F-6 | F-7 | F-8 | F-9 |
| Composition for layer of low | L1 | L2 | L3 | L4 | L5 | L6 | L7 | L8 | L9 |
| refractive index | | | | | | | | | |
| Film thickness of layer of low | 100 | 100 | 100 | 100 | 100 | 100 | 100 | 100 | 120 |
| refractive index (nm) | | | | | | | | | |
| Ra (nm) | 10 | 6 | 6 | 7 | 6 | 12 | 10 | 7 | 9 |
| Average primary particle diameter | 60 | 60 | 60 | 60 | 60 | 60 | 60 | 60 | 120 |
| R (nm) of inorganic particles | | | | | | | | | |
| Ka/R | 1.05 | 1.10 | 1.23 | 1.23 | 1.34 | 1.10 | 1.10 | 1.10 | 1.15 |
| Kh/R | 0.17 | 0.17 | 0.18 | 0.18 | 0.17 | 0.36 | 0.30 | 0.24 | 0.20 |
| Refractive index | 1.423 | 1.437 | 1.462 | 1.462 | 1.475 | 1.437 | 1.437 | 1.437 | 1.413 |
| Filling rate (%) | 45 | 39 | 28 | 28 | 22 | 39 | 39 | 39 | 34 |
| Repetitive folding resistance | 1.9 | 2.0 | 2.0 | 2.0 | 2.0 | 1.5 | 2.0 | 1.5 | 1.5 |
| (Number of times of bending until | | | | | | | | | |
| breakage: ten thousand times) | | | | | | | | | |
| Average reflectivity | A | A | B | B | B | B | B | A | C |
| Repeated folding antireflection | C | A | A | A | A | C | C | B | A |
| durability | | | | | | | | | |
| Pencil hardness | B | A | A | A | A | C | B | A | B |

From the results above, it is understood that the antireflection film according to the example of the present invention has excellent repetitive folding resistance, excellent antireflection properties, and the decrease in the antireflection properties after the repetitive folding (repetitive folding antireflection durability is excellent) is suppressed. It is understood that the pencil hardness is also excellent.

What is claimed is:

1. An antireflection film comprising:
a substrate; and
a layer of a low refractive index,
wherein the layer of a low refractive index contains inorganic particles and a binder resin,
in a case where an average primary particle diameter of the inorganic particles is set as R, and a particle spacing is set as K, an average particle spacing Ka satisfies Expression (1), and a full width at half maximum Kh in a distribution curve of the particle spacing K satisfies Expression (2), and
a surface roughness of a surface of the layer of a low refractive index on an opposite side of the substrate is 20 nm or less.
Ka≥1.1R (1)
Kh≤0.25R (2)

2. The antireflection film according to claim 1,
wherein the number of times of bending until breakage measured by a MIT tester in conformity with JIS P 8115:2001 is 10,000 times or more.

3. The antireflection film according to claim 1,
wherein an average primary particle diameter R of the inorganic particles is 200 nm or less.

4. The antireflection film according to claim 1,
wherein the inorganic particle is an inorganic particle having a hollow structure.

5. The antireflection film according to claim 1, further comprising:
a hard coat layer between the substrate and the layer of a low refractive index.

6. The antireflection film according to claim 1,
wherein a pencil hardness with a load of 500 g measured in conformity with JIS K 5600-5-4:1999 is 2H or more.

7. The antireflection film according to claim 1,
wherein an average reflectivity in a wavelength range of 450 to 650 nm is 2% or less.

8. The antireflection film according to claim 1,
wherein the substrate contains an aromatic polyamide.

9. The antireflection film according to claim 1,
wherein the Kh is 0.20R or less.

10. The antireflection film according to claim 1, further comprising:
a hard coat layer between the substrate and the layer of a low refractive index,
wherein an average primary particle diameter R of the inorganic particles is 200 nm or less, and the inorganic particles is an inorganic particle having a hollow structure, and
the substrate contains an aromatic polyamide.

11. A polarizing plate comprising:
the antireflection film according to claim 1.

12. An image display device comprising:
the antireflection film according to claim 1.

13. An image display device comprising:
the polarizing plate according to claim 11.

14. An antireflection product comprising:
the antireflection film according to claim 1.
